(19) United States
(12) Patent Application Publication
(10) Pub. No.: US 2026/0142909 A1
(43) Pub. Date: May 21, 2026

(54) SYSTEM AND METHOD FOR IDENTIFYING ROUTE DAMPENING IN A HYBRID MULTI-CLOUD NETWORK

(71) Applicant: ALKIRA, INC., San Jose, CA (US)

(72) Inventors: Joshua Bottelberghe, Vancouver, WA (US); Arjun Sreekantiah, San Jose, CA (US); Shaival Rajan Shah, Durham, NC (US)

(21) Appl. No.: 19/394,548

(22) Filed: Nov. 19, 2025

Related U.S. Application Data
(60) Provisional application No. 63/722,564, filed on Nov. 19, 2024.

(51) Int. Cl. H04L 45/03; H04L 41/0604; H04L 45/74

(52) U.S. Cl. CPC H04L 45/03; H04L 41/0627; H04L 45/742

(57) ABSTRACT

A system and a method are disclosed for managing route information in a distributed network environment. The method includes monitoring routing information associated with a plurality of routes within the distributed network environment, and recording a stability value for each of the plurality of routes. The method further includes classifying the plurality of routes into a first set of routes identified as unstable based on the stability value and a second set of routes identified as stable. The first and second set of routes are processed according to different processing paths, wherein the first set of routes is processed through a first processing path that limits or defers computational operations associated with route updates, and the second set of routes is processed through a second processing path that updates a network representation reflecting current route information.

### CROSS-REFERENCE TO RELATED APPLICATION

This application claims the benefit of priority to U.S. Provisional Patent Application No. 63/722,564 entitled “A SYSTEM AND METHOD FOR IDENTIFYING ROUTE DAMPENING IN A HYBRID MULTI-CLOUD NETWORK” filed on Nov. 19, 2024 which is incorporated herein by reference.

### TECHNOLOGICAL FIELD

The present invention generally relates to computer networks and cloud computing systems. More particularly, the present invention relates to systems and methods for identifying and mitigating route instability across distributed cloud networks.

### BACKGROUND

In large-scale network environments, multiple routing entities exchange route information to establish and maintain network connectivity. These routing entities may operate across various platforms, service providers, or administrative domains, and the routing information may change frequently as network conditions evolve.

In current practice, certain routes within such network environments may become unstable and exhibit route flapping that generally occurs when a route is repeatedly advertised and withdrawn within short intervals. Route flapping can arise from configuration changes, transient connectivity issues, or dynamic adjustments in network policies and routing protocols.

When these unstable routes are propagated throughout the network, they may result in frequent updates to routing information and lead to increased processing activity across devices or management systems that monitor and visualize network state. The continual exchange of rapidly changing route information may also contribute to delays or inconsistencies in how network connectivity is represented within monitoring or analytics platforms.

### SUMMARY

In one embodiment, the present invention provides a computer implemented method for managing route information in a distributed network environment. The method may comprise monitoring routing information associated with a plurality of routes within the distributed network environment, and recording a stability value for each of the plurality of routes. The method may further comprise classifying the plurality of routes into a first set of routes comprising routes identified as unstable based on the stability value and a second set of routes comprising routes identified as stable. The method may further comprise processing the first set of routes and the second set of routes according to different processing paths, wherein the first set of routes is processed through a first processing path that limits or defers computational operations associated with route updates, and the second set of routes is processed through a second processing path that updates a network representation reflecting current route information. The method may further comprise storing or providing information identifying at least the first set of routes as routes exhibiting unstable behavior.

In one embodiment, the method may further comprise increasing the stability value for a route of the plurality of routes responsive to each detected change in the routing information associated with the corresponding route, and decreasing the stability value over time according to a decay function.

In one embodiment, the decay function may comprise halving the stability value after a predetermined half-life interval has elapsed since a last route update.

In one embodiment, the stability value is reset when a maximum tracking interval has elapsed.

In one embodiment, the method may further comprise comparing the stability value for each route with a threshold value and assigning the route to the first set or the second set of routes based on the comparison.

In one embodiment, the threshold value may be dynamically configurable based on network policy, tenant profile, or observed update rate.

In one embodiment, monitoring the routing information may comprise detecting changes to one or more route tables of network nodes and generating delta data representing updated routes.

In one embodiment, the method may further comprise exporting the first set and the second set of routes to separate logical stores or directories within a storage system.

In one embodiment, the separate logical stores may comprise a dampened-route store and an undampened-route store, each accessible independently by downstream processing components.

In one embodiment, the first processing path may include marking each route of the first set as unstable in a data structure configured to store route identifiers and stability metadata and bypassing one or more computational stages used for the second processing path.

In one embodiment, bypassed computational stages may include re-computation of a route cache that aggregates routes from multiple sources.

In one embodiment, the second processing path may include aggregating, deduplicating, and updating a route cache representing stable routes of the second set of routes.

In one embodiment, the method may further comprise providing, through an application programming interface, information identifying routes of the first set and the second set of routes to a user interface.

In one embodiment, the method may further comprise causing the user interface to display a network representation in which routes of the first set of routes are visually distinguished from routes of the second set of routes.

In one embodiment, the displaying may include preventing the first set of routes from initiating visualization refreshes while still providing access to their identifiers and instability indicators.

In one embodiment, the method may further comprise generating alerts or recommendations for network entities associated with the first set of routes to facilitate configuration verification or remediation.

In one embodiment, the first processing path may execute within a shorter processing interval than the second processing path to provide identification of unstable routes within a processing interval shorter than that of the second processing path.

In one embodiment, the method may further comprise periodically re-evaluating the first set of routes and migrating specific routes from the first set of routes to the second set of routes upon determining that the specific routes are stabilized.

In one embodiment, the present invention provides a system for managing route information in a distributed network environment. The system may comprise one or more processors and one or more memory devices storing instructions. The one or more processors execute the instructions and cause the system to monitor routing information associated with a plurality of routes within the distributed network environment, record a stability value for each of the plurality of routes, and classify the plurality of routes into a first set of routes comprising routes identified as unstable based on the stability value and a second set of routes comprising routes identified as stable. The system may also process the first set of routes and the second set of routes according to different processing paths, wherein the first set of routes is processed through a first processing path that limits or defers computational operations associated with route updates, and the second set of routes is processed through a second processing path that updates a network representation reflecting current route information. The system may also store or provide information identifying at least the first set of routes as routes exhibiting unstable behavior.

In one embodiment, the present invention provides a non-transitory computer-readable medium storing instructions that, when executed by one or more processors, cause the one or more processors to perform a method. The method may comprise monitoring routing information associated with a plurality of routes within a distributed network environment, recording a stability value for each of the plurality of routes, and classifying the plurality of routes into a first set of routes comprising routes identified as unstable based on the stability value and a second set of routes comprising routes identified as stable. The method may further comprise processing the first set of routes and the second set of routes according to different processing paths, wherein the first set of routes is processed through a first processing path that limits or defers computational operations associated with route updates, and the second set of routes is processed through a second processing path that updates a network representation reflecting current route information. The method may further comprise storing or providing information identifying at least the first set of routes as routes exhibiting unstable behavior.

In one embodiment, the system and method of the present invention may implement different processing paths for routes classified as stable and unstable. After classification, the central control plane may direct the first set of routes (unstable routes) to a first processing path and the second set of routes (stable routes) to a second processing path. The first processing path may include operations performed by a damp route processor, which retrieves route files from a dedicated storage directory for dampened routes and records minimal route identifiers and stability metadata in a local data structure. This first processing path may bypass one or more compute-intensive stages—such as cache aggregation or deduplication—performed in the second processing path, thereby reducing latency and system load. The second processing path, executed by a cache compute component, processes routes of the second set to generate a comprehensive route cache representing the current stable network state. The separation of these paths enables the system to maintain an updated view of the stable network while isolating unstable routes in a deferred or simplified workflow. In some embodiments, each path may execute asynchronously or within independent processing threads, allowing concurrent operation and improved responsiveness of the route visualization service.

### BRIEF DESCRIPTION OF THE DRAWINGS

FIG. 1 is a block diagram that illustrates an exemplary network environment for aggregating network information in a hybrid multi-cloud network system, in accordance with an embodiment of the invention.

FIG. 2 is a block diagram that illustrates an exemplary CXP node configuration system in a hybrid multi-cloud network system, in accordance with an embodiment of the invention.

FIG. 3 is a block diagram that illustrates an exemplary central control plane for aggregating network information in a hybrid multi-cloud network system, in accordance with an embodiment of the invention.

FIG. 4 is a block diagram that illustrates an exemplary cache compute for aggregating network information in a hybrid multi-cloud network system, in accordance with an embodiment of the invention.

FIG. 5A is a block diagram that illustrates an exemplary node in a cloud exchange platform for aggregating network information in a hybrid multi-cloud network system, in accordance with an embodiment of the invention.

FIG. 5B is a block diagram that illustrates an exemplary node with route dampening in a cloud exchange platform for aggregating network information in a hybrid multi-cloud network system, in accordance with an embodiment of the invention.

FIG. 6 is a block diagram that illustrates an exemplary central control plane with route dampening for aggregating network information in a hybrid multi-cloud network system, in accordance with an embodiment of the invention.

FIG. 7 is a flowchart that illustrates an example of a method for determining a dampened route in a hybrid multi-cloud network system, in accordance with an embodiment of the invention.

FIG. 8 is a flowchart that illustrates an example of a method for identifying unstable routes and reporting the unstable routes to customer portal in a hybrid multi-cloud network system, in accordance with an embodiment of the invention.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the embodiments of the present invention are described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

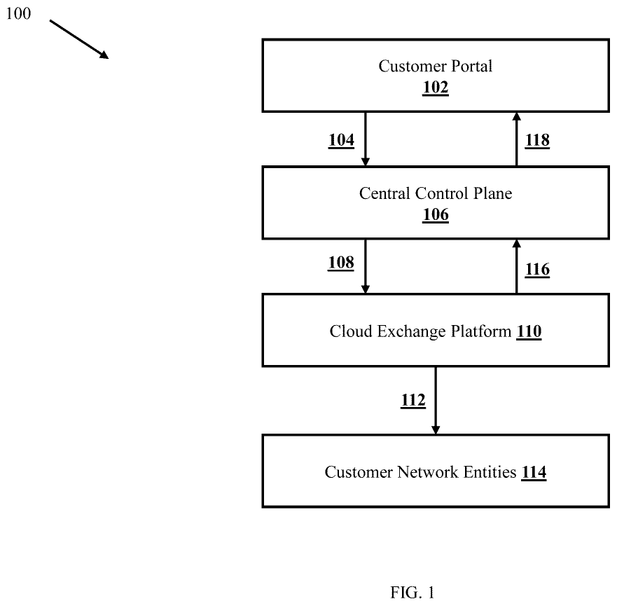

FIG. 1 is a block diagram that illustrates an exemplary network environment for aggregating network information in a hybrid multi-cloud network system, in accordance with an embodiment of the invention. With reference to FIG. 1, there is shown a network environment 100. The network environment 100 may include a customer portal 102, a central control plane 106, a cloud exchange platform (CXP) 110, and customer network entities 114. Customers provide network configurations 104 for the customer network entities 114 via the customer portal 102. The central control plane 106 listens to these network configurations and instructs 108 the CXP 110 to apply 112 these network configurations to the customer network entities 114. After receiving updates regarding the deployment of the network configurations in the customer network entities, the CXP 110 reports 116 these updates to the central control plane 106. The customer portal 102 listens 118 to these updates and reports these updates as current network connectivity and status for customer access.

### Customer Portal

In an embodiment, the customer portal 102 may be a customer facing website where customers can manage their cloud network comprising network entities 114. At the customer portal 102, the route information collected from the network is shown in aggregate to the customer. The customer portal 102 is a single-point access platform that delivers network connectivity and status on a real-time basis through a login experience. Based on specific needs, the customer portal 102 may act as a gateway, providing customers with personalized information regarding their networks deployed across multiple cloud services such as, but not limited to Amazon Web Services (AWS), Microsoft Azure, Google Cloud Platform (GCP), or IBM Cloud.

### Central Control Plane

In an embodiment, the central control plane 106 may be a global control plane including, but not limited to, Kubernetes services managing customer data. Kubernetes is an open-source system for automating deployment, scaling, and management of containerized applications.

The central control plane 106 may also include an API gateway responsible for providing the information to the customer portal 102. The central control plane 106 implements API and associated backend function for services implemented in the hybrid multi-cloud network system 100. The API defines top level abstractions to achieve bidirectional communication between entities involved in the aggregation of network information in the hybrid multi-cloud network system 100.

The central control plane 106 is intended to represent a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

### Cloud Exchange Platform

In an embodiment, the CXP 110 may include cloud regions containing nodes acting as routers for the hybrid multi-cloud network system. The nodes may be deployed in all places where customers have cloud resources to ensure the best connectivity and network performance.

The CXP 110 is intended to represent a system that establishes connectivity, instantiates services for corresponding geolocations, aggregates data, implements policies, monitors traffic, and/or provide analytics across disparate cloud service providers and different connectivity architectures such as, but not limited to, AWS, Microsoft Azure, GCP, or IBM Cloud. In a specific implementation, the CXP 110 operates in a manner that—to the customer—is connectivity agnostic and cloud provider agnostic. The CXP 110 may correspond to aggregated services offered for a given region or set of regions, where the regions may comprise one or more zones corresponding to subsections of such regions. The CXP 110 may service a branch network within a particular region, and multiple CXPs may be stitched together as part of a larger cloud servicing network (e.g., mesh network, hub-and-spoke network, or a network having some other topology) to span multiple regions. In a specific implementation, the CXP 110 provides a portal through which a network administrator or other user associated with a customer may (i) view and select SaaS/laaS/other services from a range of providers (or provided by the customer itself) within a common dashboard, (ii) manage connectivity (e.g., MLPS, SD-WAN, IPsec, etc.), (iii) monitor traffic, (iv) control traffic in accordance with one or more policies (e.g., security policies), etc. In a specific example, CXPs are deployed in different availability zones for redundancy. All the connections from users, branches and workloads will be multihomed to CXP in each availability zone.

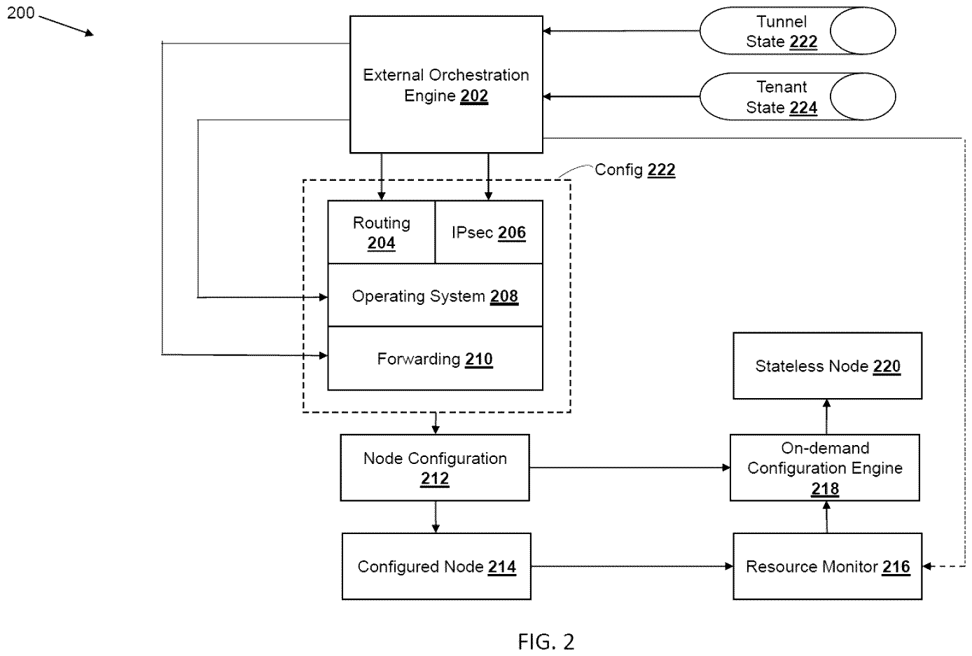

The CXP 110 may include, in addition to other critical components, a routing component and a forwarding component as described in further detail with reference to description of FIG. 2. The forwarding and routing components hold a routing and forwarding table to keep a record of routes or rules that determine where the network traffic from a set of subnets of different segments are directed. The routing and forwarding table is also responsible for storing the next hop of each network and identifying a frame type. Customers may send changes to the network and the CXP 110 will make the required changes and then report the status of the network after the change to the customer via the customer portal 102.

### Customer Network Entities

In an embodiment, the customer network entities 114 may include cloud sites and on-premise resources. The difference between on-premise vs cloud sites is the location. On-premise entities are deployed and hosted locally, whereas cloud sites are deployed on cloud regions. In an example embodiment, all remote locations connect to their closest cloud exchange point, leveraging a variety of on-premises connectors, such as IPSec VPN, SD-WAN, or private cloud cross-connect, for example and not limited to, AWS direct connect or Azure express route. Network configurations related to the customer network entities 114 may refer to internet endpoints and network information a customer has relevant to maintaining the network. In an example, the network configurations may include, but not limited to, internet connectors such as IPsec, SD WAN, AWS Direct Connect, or VMWare, cloud connectors such as, but not limited to, AWS VPC, Azure VNET, Google VPC, and network policies including Network Address Translation (NAT) policy, Network Segment Sharing policy, or Network Rules.

FIG. 2 is a block diagram that illustrates an exemplary CXP node configuration system in a hybrid multi-cloud network system, in accordance with an embodiment of the invention. With reference to FIG. 2, there is shown a CXP node configuration system 200. The CXP node configuration system 200 includes an external orchestration engine 202, a routing component 204 coupled to the external orchestration engine 202, an IPsec component 206 coupled to the external orchestration engine 202, an operating system (OS) component 208 coupled to the external orchestration engine 202, and a forwarding component 210 coupled to the external orchestration engine 202. The routing component 204, the IPsec component 206, the OS component 208, and the forwarding component 210 can be collectively referred to as a configuration data structure 222.

The CXP node configuration system 200 further includes a node configuration datastore 212 coupled to the configuration data structure 222, which represents a communication medium from the external orchestration engine 202 over which the configuration data structure is provided for storage in the node configuration datastore 212, a configured node 214 coupled to the node configuration datastore 214, a resource monitor 216 coupled to the configured node 214, an on-demand configuration engine 218 coupled to the resource monitor 216 and the node configuration datastore 212, a stateless node 220 coupled to the on-demand configuration engine 218, a tunnel state datastore 222 coupled to the external orchestration engine 202, and a tenant state datastore 224 coupled to the external orchestration engine 202.

The external orchestration engine 202 is intended to represent an engine that knows tunnel state (represented by the tunnel state datastore 222), which tenant is on which node (represented by the tenant state datastore 224), and how to configure nodes. The term “external” in this context is intended to mean node-external or router-external, as in the external orchestration engine 202 is implemented outside of a router. In a specific implementation, node configuration is performed outside of nodes of a CXP, such as nodes of the CXP 110 of FIG. 1. Advantageously, a node of a CXP can be ripped and replaced due to node configuration being stored outside of the node to be replaced. It may be noted that, with this implementation, it is not necessary for redundant nodes to synch with each other, which is beneficial because redundant nodes have a cost (e.g., synch modules); node-to-node synch communication is at least ameliorated and at best eliminated using the techniques described in this paper.

The routing component 204 is intended to represent a software component implemented on a configured node, such as the configured node 214. Routing forms virtual routing and forwarding (VRF) context for a tenant.

The IPsec component 206 is intended to represent a software component implemented on a configured node, such as the configured node 214. IPsec is a secure network protocol suite that authenticates and encrypts the packets of data to provide secure encrypted communication between two computers over an Internet Protocol network. IPsec includes protocols for establishing mutual authentication between agents at the beginning of a session and negotiation of cryptographic keys to use during the session. In a specific implementation, the IPsec component 206 is compliant with strongSwan, a multiplatform IPsec implementation.

The OS component 208 is intended to represent a software component implemented on a configured node, such as the configured node 214. In a specific implementation, the OS component 208 is compliant with Linux.

The forwarding component 210 is intended to represent a software component implemented on a configured node, such as the configured node 214. Forwarding includes flow management enabling flow-based routing. In a specific implementation, the forwarding component 210 is compliant with vector packet processing (VPP), a software algorithm that is used to quickly process network packets.

The node configuration datastore 212 is intended to represent a datastore of configuration parameters for a node. In a specific implementation, the node configuration datastore is an etcd datastore, etcd is a strongly consistent, distributed key-value store that provides a reliable way to store data that needs to be accessed by a distributed system or cluster of machines. In a specific implementation, the provisioning of nodes is accomplished using an entity relationship diagram (ERD) tool.

The configured node 214 is intended to represent a B-node, an S-node, or a V-node. In a specific implementation, within the configured node 214 are configuration parameters such as represented in the diagram 200 as config data structure 222 (i.e., the routing component 204, the IPsec component 206, the OS component 208, and the forwarding component 210). Although the configured node 214 is coupled to the node configuration datastore 212 and, at least by implication, received configuration parameter values from the node configuration datastore 212, it should be understood that, instead or in addition, the configured node 214 could be pre-configured (i.e., at least partially configured prior to being coupled to the node configuration datastore 212).

The resource monitor 216 is intended to represent an engine that sends a trigger to the on-demand configuration engine 218 responsive to a stimulus from the configured node 214. Instead or in addition, the stimulus could come from some other source, such as the external orchestration engine 202, which is represented in the diagram 200 as a dotted arrow from the external orchestration engine 202 to the resource monitor 216. The stimulus is indicative of a need to spin up additional nodes to handle network resource consumption.

The on-demand configuration engine 218 is intended to represent an engine that provides node configuration parameter values to the stateless node 220 in response to a trigger from the resource monitor. In a specific implementation, the trigger is an indication that additional nodes are needed to handle network resource consumption. If network resource consumption decreases, the stimulus from the configured node 214 to the resource monitor 216 could also trigger the on-demand configuration engine 218 to tear down nodes (not shown).

The stateless node 220 is intended to represent a node that is not initially employed to handle network resource demands (e.g., traffic). Upon obtaining configuration parameter values from the node configuration datastore 212 via the on-demand configuration engine 218, where the configured node 214 is a first configured node, the stateless node 220 becomes a second configured node. In an alternative, the stateless node 220 could initially be handling network resource demands but its configuration is changed by the on-demand configuration engine 218 upon receipt of a trigger at the on-demand configuration engine 218 from the resource monitor 216.

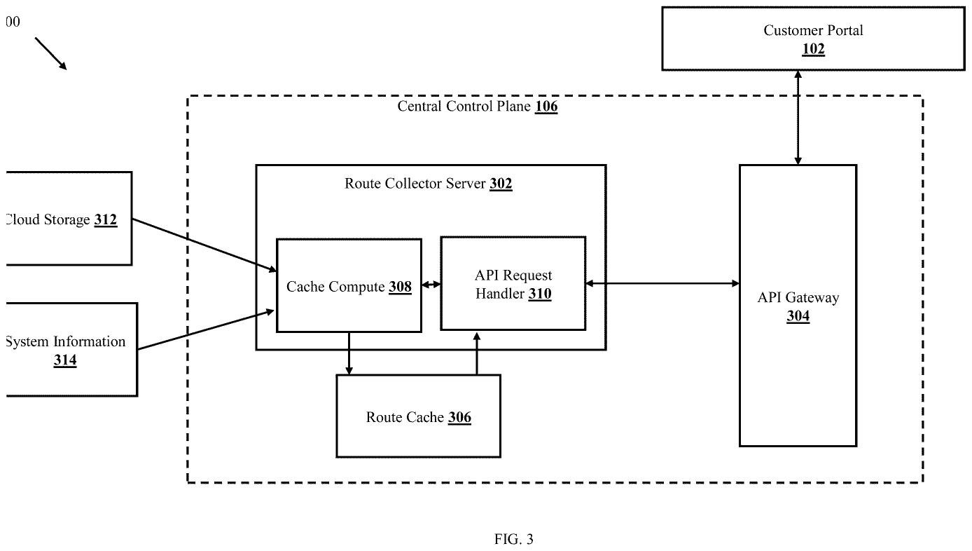

FIG. 3 is a block diagram that illustrates an exemplary central control plane for aggregating network information in a hybrid multi-cloud network system, in accordance with an embodiment of the invention. FIG. 3 is explained in conjunction with elements from FIG. 1. With reference to FIG. 3, there is shown a block diagram 300 of the central control plane 106. The central control plane 106 may include a route collector server 302, an API gateway 304, and route cache 306. The API gateway 304 is communicatively coupled to the customer portal 304 and the route collector server 302. The route collector server 302 may include a cache compute 308 and an API request handler 310. The route cache 306 is communicatively coupled to both the cache compute 308 and the API request handler 310. The cache compute 308 listens to the route data or change in the route data stored in a cloud storage 312. The cache compute may also listen to other information related to the hybrid multi-cloud such as system information 314.

### Route Collector Server

In an embodiment, the route collector server 302 may be a golang service running in a Kubernetes cluster in the central control plane 106. In another embodiment, the route collector server 302 may be deployed on a processor or circuitry which may perform operations for collecting network information such as route data from the cloud storage 312, processing the collected network information, and reporting the processed network information of the hybrid multi-cloud network system to the customer portal 102 via the API gateway 304. This is the service which collects all information needed for the route cache, it processes it together and provides it via API so routes can be viewed from the system.

The processor or the circuitry may include suitable logic, circuitry, and interfaces that may be configured to execute program instructions associated with different operations to be executed by the route collector server 302. For example, some of the operations may include reception of route information from the cloud storage 312 and system information 314, creating or computing a cache that contains all important information about each route 308, and reporting the route information to the customer portal 102 via the API gateway 304. The processor or the circuitry may include one or more specialized processing units, which may be implemented as a separate processor. In an embodiment, the one or more specialized processing units may be implemented as an integrated processor or a cluster of processors that perform the functions of the one or more specialized processing units, collectively. The processor or the circuitry may be implemented based on a number of processor technologies known in the art. Examples of implementations of the circuitry 202 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

On API call between the customer 102 and the central control plane 106, the API request handler 310 builds a key to a database, such as the route cache 306, with the information provided in the API query from the customer portal 102, retrieves the route data from the route cache 306, and filters it before returning it to the customer portal 102.

### API Gateway

In an embodiment, the API gateway 304 is an API management tool that sits between the customer portal 102 and the central control plane 106 interfacing with multiple cloud sites or on-premises resources residing on nodes spread across the hybrid multi-cloud network. API stands for application programming interface, which is a set of definitions and protocols for building and integrating application software.

The API gateway 304 is a component of application delivery (the combination of services that serve an application to users) and acts as a reverse proxy to accept all application programming interface (API) calls, aggregate the various services required to fulfill them, and return the appropriate result. In other words, the API gateway 304 is a piece of software that intercepts API calls from the customer portal 102 and routes them to the appropriate backend service such as reports generated by the route collector server 302.

In order to provide data to the customer website or the customer portal 102, services in the central control plane 106 are exposed through the API gateway 304 which is a common solution to protect services with exposed APIs to unwanted internet traffic and protect the network requests from the customer. The API gateway 304 handles all external API requests to the central control plane 106 to verify credentials and validity of the requests.

### Route Cache

In an embodiment, the route cache 306 includes the stored route information. Route information can be quite large in size so it is broken up into keys and values and stored in redis. However, it is not limited to redis only. Other external databases may also be used instead. The route cache 306 allows the data to be stored in a safe place and not slow down the service from excess system memory.

In an example use case, redis is a service used by the route collector server 302 to store the route cache 306 and other large route data. Officially redis is an open-source, in-memory, key/value store NoSQL database. A deployment of redis may be hosted within the central control plane 106 and the route collector server 302 service has access to it. Route data may be stored (by encoding in JSON format) into redis to offload memory from the service. Keeping the routes in memory for route collector server slows down service performance and the data should be offloaded to redis until it is needed. Both the route data from the nodes and the route cache produced by the cache compute 308 are each separately stored in redis. This data is large and takes too many system resources to maintain in memory all the time.

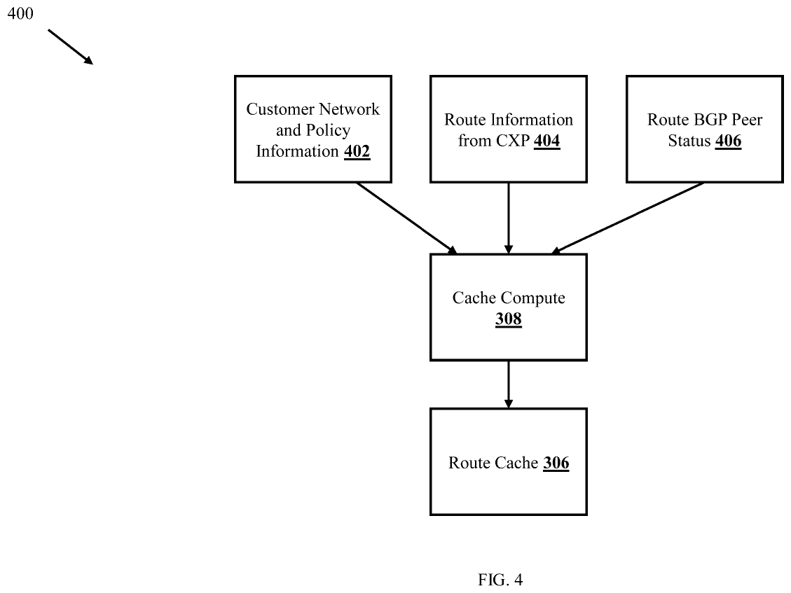

In an example use case in the hybrid multi-cloud network, the route collector server 302 downloads route files or information or data from the cloud storage 312. An example of the cloud storage 312 may be AWS S3. However, the cloud storage is not limited to AWS S3 only and other cloud storage options are also applicable. Any update in the routing table stored in the nodes hosted across multiple cloud regions is stored as the route files in the cloud storage 312. Cache compute 308 of the route collector server 302 listens to the route files from the cloud storage 312 and computes cache. In another embodiment, the cache compute 308 may also listen to other system information 314 to compute the cache. The other system information 314 may include information about policies in the network as well as mappings of IP addresses and route entities with their real names, for example, connector ID 45516 is used with this data to add the connector name aws-west-2-ipsec to the route. The route cache 306 stores the information computed by the cache compute 308. Details of the processes and functions preformed in the cache compute 308 can be found in more detail with reference to description of FIG. 4.

As and when the customer desires to see the current network connectivity and the status of the network deployed across multiple cloud regions, the customer provides such request through the customer portal 102. The customer portal 102 makes API call to the route collector server 302 via the API gateway 304 to report the information computed by the cache compute 308. Upon receiving the API call, the API request handler 310 builds the key to the route cache 306 with the information provided in the API call, retrieves (from the route cache 306) the information computed by the cache compute 308, and sends the information to the customer portal 102. The customer portal 102 takes the information and displays the routes in a way the customer finds useful.

### Cache Compute

FIG. 4 is a block diagram that illustrates an exemplary cache compute for aggregating network information in a hybrid multi-cloud network system, in accordance with an embodiment of the invention. FIG. 4 is explained in conjunction with elements from FIGS. 1 and 3. With reference to FIG. 4, there is shown a block diagram 400 that further describes the process employed for the cache compute 308 as indicated in FIG. 3. In an embodiment, the cache compute 308 may use one or more of customer network and policy information 402, route information from CXP 404, and route BGP peer status 406 to compute cache and store in the route cache 306.

The customer network and policy information 402 refers to stored information about network connectors and network policies. This is fetched by API call from another central control plane service called the Tenant Provisioning Service (TPS). The TPS takes into account the intent of the customer from filling a service provider specific form provided on a website of the service provider. In an embodiment, the service provider may be a provider of the hybrid multi-tenant cloud network system. The customer network and policy information 402 is translated to network configuration and the stored configuration is exposed by an API.

The route information from CXP 404 includes information related to the route tables stored in the cloud storage 312. The cloud storage 312 stores the updated route tables by listening to the updates in the nodes sitting in the CXP 110. In an example, the cloud storage may be AWS S3. In this specific example use case, route information 404 is fetched from AWS S3 by the AWS tooling in golang with the needed AWS credentials.

The route BGP peer status 406 may be referred to as system information, the status of routes as captured from Border Gateway Protocol (BGP) or stored (in a service called Prometheus) to be monitored. The status of the routes may indicate whether the routes are up or down. The status of the routes may also indicate whether the route connection is running or not. This information is collected by the route collector server 302 so that if a route or BGP path is down it is not included in the cache.

The cache compute 308 is the process of processing the customer network and policy information 402, route information from CXP 404, and route BGP peer status 406, and creating a cache that includes all important information about each route.

In an embodiment, the cache compute 308 may be processed using the below two steps:

Step 1: Iterate through all route tables for a tenant and add the routes to an aggregate route list
func processRoutesForSegment(routes RouteInfo):
for each route:

| | |
|---|---|
| - | Check if the route should be added to the cache (internal routes, or routes that |
| | go to the alkira nodes, are not shown to the customer as they are part of the |
| | routing system |
| - | Collect route connector name and information from stored TPS data and add to |
| | route |
| - | Other minor route validations and data collection |

```
    return the collected validate routes
func computeRouteCache( ):
    var routes RouteCache // stores routes
    for each node's route table:
```

routes := append(routes, processRoutesForSegment(nodeSegment))

```
    // now all routes are collected in one cache
    ... proceed to post processing
Step 2: Refine Routes in collected Route Cache
func computeRouteCache( ):
    ...
    Route aggregation
    ...
    // Process NAT and shared routes
NAT (network address translation) and segment share (routes shared from
one route table to another) routes are handled after all routes are collected because they require
information from all routes to be collected first
    // Sort and remove duplicates
Sort the routes and remove duplicates (fastest to do this together)
Duplicates can occur from nodes in the system that provide redundancy and have the same
route path
    // mark overlap routes
Routes that are overlapping (two routes being advertised over each other) are marked now that
information about other routes has been collected. These routes are displayed separately to the
customer in the UI because they will want to resolve these routes. Done to avoid asymmetric
routing.
    // store routes in redis
    marshal routes as a string of JSON and store in redis
    done
```

### Route Dampening

Routes in customer networks can often be “unstable” or “flapping” due to several networking scenarios that interfere with the ideal working conditions of the router. When there are routes that are unstable/flapping, the network state becomes inconsistent. This is problematic for the performance of the network as well as the route visualization process itself. Frequent route updates cause latency in this visualization process. Route flapping may be a networking issue in which the state of the router fluctuates within a short period of time. In an example, the route flapping may define scenarios where the routers constantly switch between being an available state and an unavailable state, update and withdraw network prefixes (thereby alternatively advertising the two best destination routes), or display drastic changes in any of the routing metrics (such as the BGP table version).

As an example, if a router updates route A to be the best route in its first broadcast, then immediately withdraws it and updates route B to be the best route in its second broadcast, and again updates route A as the best route, the router is flapping. In an example, route flapping may be detected through network packet sniffers, availability monitoring, or manual inspection of router metrics.

Route flapping may severely affect the entire network if left unmanaged. A router that intensively alternates between two destination routes can cause confusion in network traffic routing, thereby causing all connected routers to recalculate the topology frequently. This can easily disrupt the network topology, causing all the upstream connected routers to flap. Unnecessary recalculations and route updates caused by route flapping put a strain on the router's CPU. Intensive CPU usage and constantly changing destination routes can affect router performance and cause network traffic to slow down.

To solve the above-mentioned issues of route flapping, this paper proposes a process of route dampening to identify and reduce network instability caused by route flapping. By tracking changes on routes in the network and using a half-life algorithm, problematic routes can be identified and then fixed.

Route Dampening solves the impact of unstable/churning/flapping routes. By identifying the routes we can assign a lower priority to providing updates about these routes so customers can track the ones that are stable. More importantly, customers can see these unstable routes and take this as an indication that something is wrong with these routes and can go and fix them. Fixing these routes will result in a stronger network.

Route Dampening is the process of tracking the updates on routes and assigning a threshold for changes. When this threshold is reached the route is considered dampened. Route visualization is notified this route is dampened and will then mark it on the visualization pages. Additionally, these routes will no longer on their own cause updates to the viz page reducing compute power needed to keep the cache up to date.

The route dampening process identifies routes in unstable states, marks these unstable routes, and reports these unstable routes to the customers. After identifying these routes, they are prevented from causing extra visualization updates. The routes are then marked to the customer as potentially problematic routes. Removing the extra updates will improve the latency of network information reaching the customer portal while marking routes can lead to discovery of ways the network can be improved.

In an embodiment, a portion of the route dampening process may be executed at the nodes present in the CXP 110 and a portion of the route dampening process may be executed in the central control plane 106. However, the route dampening process is not limited to be executed only in the CXP 110 and the central control plane 106. A person skilled in the art would appreciate that all elements of the hybrid multi-cloud network system could contribute to the execution of the route dampening process.

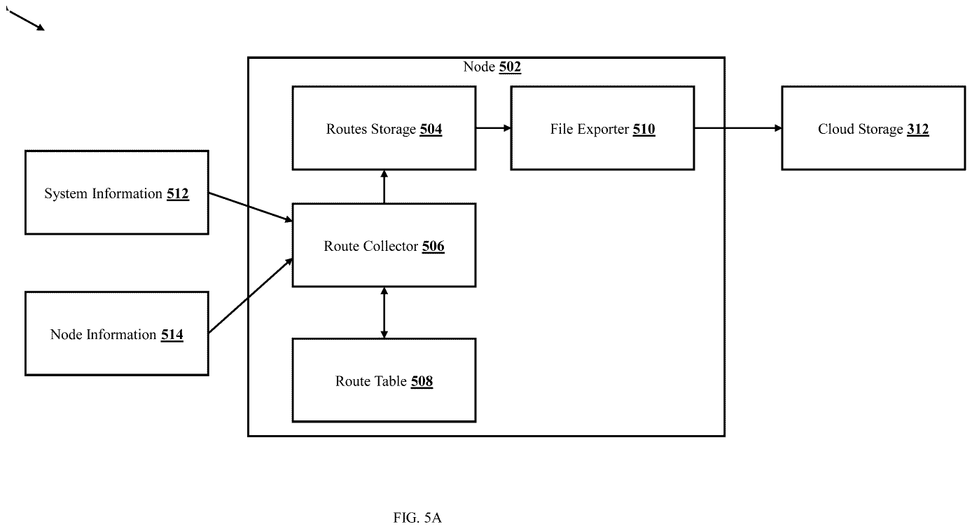

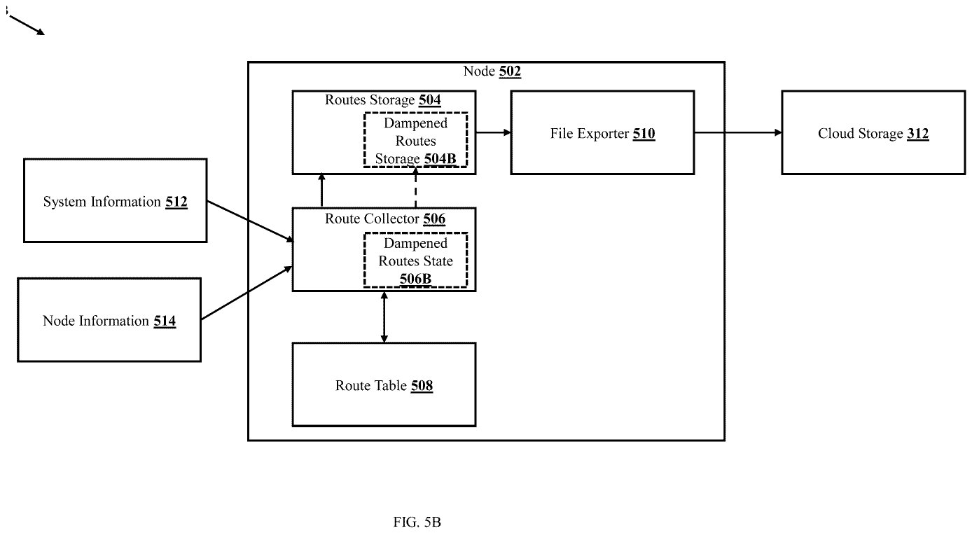

FIG. 5A is a block diagram that illustrates an exemplary node in a cloud exchange platform for aggregating network information in a hybrid multi-cloud network system, in accordance with an embodiment of the invention. FIG. 5A is explained in conjunction with elements from FIGS. 1 and 2. With reference to FIG. 5A, there is shown a block diagram 500A that includes a node 502 and the cloud storage 312. In an embodiment, the node 502 is one of the multiple nodes of the CXP 110 as described with reference to FIGS. 1 and 2.

The nodes in CXP may be spread across the world and may be associated with different cloud providers such as AWS, Azure etc. The node 502 has a route table 508 stored in it. Different routes connect to the node 502. The route table 508 is stored in a file system on the node 502. The node 502 includes a route collector 506 that reads the route table 508 and stores the information extracted from the route table 508 into the routes storage 504. In an alternative embodiment, the route collector 506 may also read the system information 512 and node information 514 to extract additional information in relation to the route table 508 and store it in the routes storage 504. In an embodiment, the routes storage 504 may be an EC2 instance. The routes stored in the route storage 504 are the routes processed by the route collector 506. The route table 508 changes in response to changes in the computer network. The routes stored in the route storage 504 are processed route tables stored in files to be exported to the cloud storage 312 such as AWS S3

In an example, the route table may be generated on the node 502 from its connections to other entities in the hybrid multi-cloud network. In an example, the system information 512 and the node information 514 may include information learned from other nodes in the region of the cloud where the node 502 is hosted and information about the node itself. This information is included on the routes. In an example, in the routes storage 504, the route information is packaged into JSON format and stored in a JSON file on the node 502.

The node 502 has a file exporter process 510 to export all information from the routes storage 504 to the cloud storage 312. This happens on all the nodes across the network.

Whenever, the route table 508 is updated due to any change in the routes advertised in the network, the route collector 506 listens to that update and processes this updated information based on the system information 512 and the node information 514 to generate information specific to the updated route table 508. This generated information is stored in the routes storage 504 which is again exported to the cloud storage 312 by the file exporter 510. In this way, every update in the route table 508 will result in a file (specific to the corresponding update) to be stored in the cloud storage 312. The effect of routes flapping or churning on the node 502 is described in reference to description of FIG. 5B.

FIG. 5B is a block diagram that illustrates an exemplary node with route dampening in a cloud exchange platform for aggregating network information in a hybrid multi-cloud network system, in accordance with an embodiment of the invention. FIG. 5B is explained in conjunction with elements from FIGS. 1, 2, and 5A. With reference to FIG. 5B, there is shown a block diagram 500B that includes the node 502 with route dampening. In a case where the routes reaching the node 502 are flapping constantly or churning, the node 502 marks such routes as dampened.

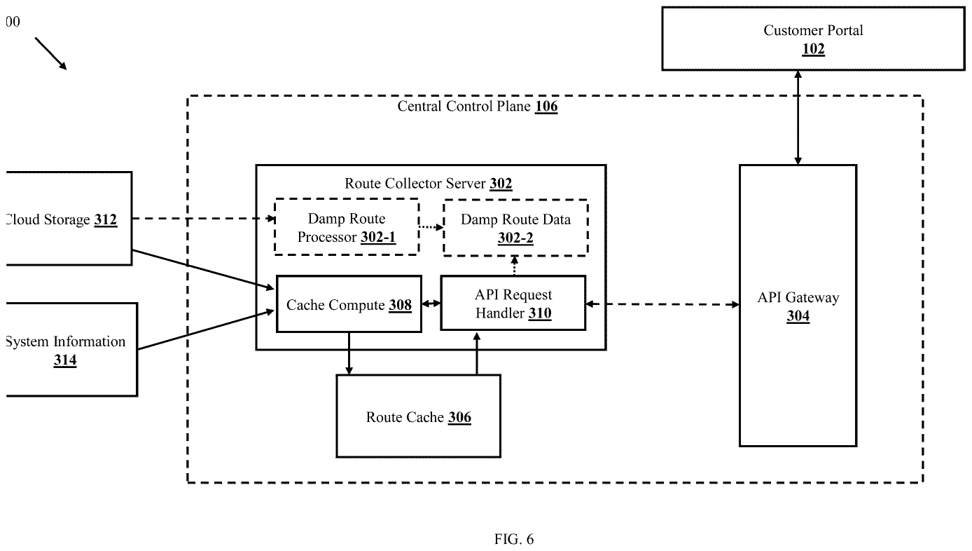

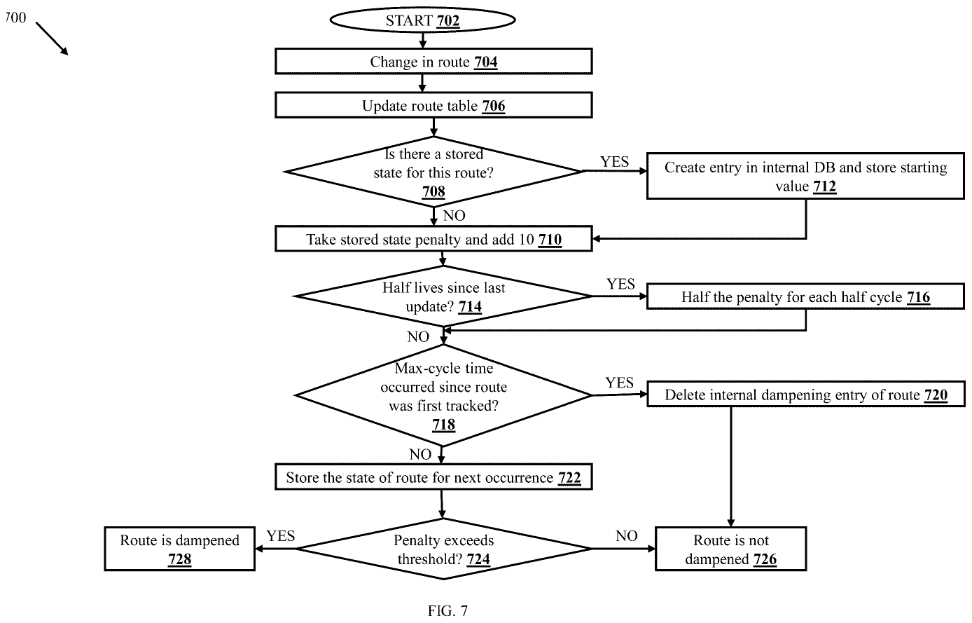

In an embodiment, the route collector 506 listens to the route table 508 periodically and keeps a check on the routes and how they are changing. The route collector 506 marks such routes as dampened and processes such routes separately as dampened routes state 506B. If there is a change that occurs to the route table 508 that occurs only to the dampened route, this change is stored in a different file directory of the node 502 and just this file is exported to the cloud storage 312. This different file directory of the node 502 to separately store the dampened route is dampened routes storage 504B and it includes the information about the dampened route file. In this way, if there is a churn or route flapping, then a file would be generated and stored in a separate file directory of the cloud storage 312 which will be used differently by the route collector server 302 (to report route dampening to the customer portal 102) as explained with reference to description of FIG. 6. The process employed by the route collector 506 to infer whether a route is dampened or not is explained in detail with reference to description of FIG. 7.

FIG. 6 is a block diagram that illustrates an exemplary central control plane with route dampening for aggregating network information in a hybrid multi-cloud network system, in accordance with an embodiment of the invention. FIG. 6 is explained in conjunction with elements from FIG. 3. With reference to FIG. 6, there is shown a block diagram 600 of the central control plane 106. In the flow forward from the route dampening information being stored as the separate file directory in the cloud storage 312, a damp route processor 302-1 of the route collector server 302 may download or listen to that separate file directory related to the dampened route only. With this every change that is pulling from the cloud storage 312, the route collector server is differently computing the cache as damp route data 302-2 and then outputting it out to the customer portal 102 via the API gateway 304. In a way, the routes go into the node 502 and the node 502 exports these routes into files. These files sit in the cloud storage 312. The route collector server 302 downloads these files and takes into consideration the system information 314 to generate the damp route data 302-2.

In an example, the route dampening information stored as the separate file directory in the cloud storage 312 may also be referred to as the damp route files. The separate file directory in the cloud storage 312 may be referred to as the dampened directory. The damp route files are route files stored in the dampened directory. The damp route files do not go through the cache compute 308 as opposed to regular route files or route files with no route dampening. Thus, saving significant time of the cache compute and reducing latency in visualization. It is not desirable for the cache in the nodes or in the router collector server to be updated with changing/flapping routes because cache update takes a long time and customers cares a lot about how fast is cache updating.

When the route collector server 302 in the central control plane 106 downloads the damp route files, it handles differently. The route collector server 302 stores these damp route files internally as damp route data 302-2 after getting processed by the damp route processor 302-1. This way, when a customer requests the network information via the customer portal 102, the customer portal 102 sends an API call to the API gateway 304 which enquires the damp route files separately using the API request handler 310. With this, the damp route data 302-2 (including the damp route files) is supplied to the customer portal 102 bypassing the cache compute 308. Thus, by storing the damp route files of the dampened routes in the separate file and treating them differently, it is evident that these files are not going through cache compute 308, thus, not triggering additional cache compute. The damp route files are going through their own flow which is very fast and light weight in terms of computational and processing time. In effect, with the proposed method of handling damp route data 302-2 differently, processing dampened routes is fundamentally easier because no correlation is done between other existing routes and the route is treated as one route independent of the cache (unlike the cache compute).

These cache computes, for example the cache compute 308, inside the route collector server 302 take much longer (about 4 minutes). If there are additional files triggering cache computes all the time, it can get the visualization slow down. Since these routes are dampened, customers don't really care so much about their most updated state change because those routes are unstable. After identifying these routes, they are prevented from causing extra visualization updates. These routes are then marked to the customer as potentially problematic routes. Removing the extra updates will improve the latency of network information reaching the customer portal while marking routes can lead to discovery of ways the network can be improved.

In one embodiment, routes identified as unstable may be stored in a data structure separate from the main route cache, configured to record only minimal information necessary to identify the unstable route and its associated stability value or timestamp. Such data structure may be implemented as a key-value table, list, or in-memory index that omits detailed routing attributes used in cache computation. By maintaining only the essential identifiers and stability metadata, the system reduces processing overhead and avoids unnecessary cache re-computation for unstable routes.

In an embodiment, the central control plane 106 may perform the marking of the dampened routes using the below steps:

```
def processDampenedFile(file DampFile):
  for each route in file:
    if route dampened:
      markDampenedRoute(route)
def handleAPI(req request):
  routes := getRoutesFromRedis(req.tenantID)
  dampRoutes := getRoutesMarkedDampenedFromMem(req.tenantID)
  for each route in dampRoutes:
    if route in routes and route.dampened:
      Mark route in routes as dampened
return routes
```

### Dampening Algorithm

FIG. 7 is a flowchart that illustrates an example of a method for determining a dampened route in a hybrid multi-cloud network system, in accordance with an embodiment of the invention. FIG. 7 is explained in conjunction with elements from FIGS. 1-4, 5A, 5B, and 6. With reference to FIG. 7, there is shown a flowchart 700. The operations from 702 to 728 may be implemented by any computing system, such as, nodes in the CXP 110 or the central control plane 106 of FIG. 1. The operations may start at 702 and may proceed to 728.

A process to determine whether a route is dampened or not may be referred to a dampening algorithm. When choosing an algorithm to identify high churning routes, the following goals are considered: (1) identify routes that are churning or flapping frequently, (2) give more penalty to more recent updates, (3) do not dampen routes that are not churning or flapping.

In an embodiment, half-life algorithm may be used in the dampening algorithm to determine dampening of the routes in the network. However, other algorithms may also be used in place of the half-life algorithm to determine the dampening of the routes.

The stepwise half-life algorithm is most applicable as it meets the goals set. Churning routes will accumulate penalty. The half-life works to reduce the penalty for changes that occurred longer ago keeping the dampening state fresh. And finally, the parameters can be tailored to the greater visualization use case to avoid suppressing routes too freely.

The dampening algorithm is a stepwise calculation of penalty, taking into consideration time since route first occurred and number of updates since then. There are four main parameters to the dampening algorithm, shown as below:
(1) Penalty: Point value assigned to one change on a route
(2) Suppressing Threshold: Penalty value at which a route is considered dampened
(3) Half Life: Time before route penalty is halved
(4) Max-Cycle: The maximum time a route is listened to. Once this time is reached, the route state is reset and starts over again
   These parameters are flexible and the values may be set as a base level and may be determined by testing the algorithm and its results on real world route data.

In an example, the formula used to calculate the penalty may be as shown below:

$$NewPenalty = ( PrevPenalty + Penalty ) - \frac{PrevPenalty + Penalty}{2 ( ⌊ \frac{timePassed}{halflifeInterval} ⌋ )}$$

At 704, a change in a route connected a node, for example node 502, in the CXP 110 occurs. At 706, the route table, for example route table 508, in the node listens to the route change and gets updated. At 708, it is checked if there is stored state for this route, for example, in the route storage 504 of the node. If there is a stored state for this route, add a specific value to the stored state penalty at 710. This specific value may be selected as 10, in an example. If there is no stored state for this route, create an entry in internal database DB and store a starting value at 712. This new entry value is then passed to step 710. The internal database DB may be the dampened routes state 506B, in an example. At 714, it is checked if there have been half lives since last update. If yes, reduce the penalty to half for each half life and pass the control to 718. If no, the control is passed to 718. At 718, it is checked if the max-cycle time has occurred since the route was first tracked. If yes, delete the internal dampening entry of the route at 720 and pass the control to 726. If no, store the state of route for next occurrence at 722. At 724, it is checked if the penalty exceeds threshold. If no, the route is declared as not dampened at 726. If yes, the route is declared as dampened at 728.

Although the flowchart 700 is illustrated as discrete operations, such as 702, 704, 706, 708, 710, 712, 714, 716, 718, 720, 722, 724, 726, and 728 the invention is not so limited. Accordingly, in certain embodiments, such discrete operations may be further divided into additional operations, combined into fewer operations, or eliminated, depending on the implementation without detracting from the essence of the disclosed embodiments.

Consider an example scenario, where parameter values are as shown below:
PENALTY: 10
THRESHOLD: 25
MAX-CYCLE: 30 minutes
HALF-LIFE: 15 minutes
   The dampening algorithm as illustrated with reference to FIG. 7 may be used to determine whether a route is dampened or not in the following scenarios:

### Iteration 1:

(T0) A route (R1) is added to the route table.
1. R1 has not been seen yet. Create an entry internally:
   R1 {Penalty: 10, time seen: T0, last halflife: T0}
2. Since this it is still T0, no half life
3. Route is still fresh, no max cycle
4. The penalty on the route is equal to the PENALTY value of 10, and has not met the THRESHOLD.
   Route is not dampened, its change is exported and updated in the cache.

### Iteration 2:

(T1-5 minutes later) R1 is updated
1. The data from R1 is pulled from memory:
   R1 {Penalty: 10, time seen: T0, last halflife: T0}
   And add the penalty for this change:
   R1 {Penalty: 20, time seen: T0, last halflife: T0}
2. Only 5 minutes have passed no half life
3. Max cycle not reached
4. The PENALTY is 20, and has not met the THRESHOLD.
   Route is not dampened, its change is exported and updated in the cache.

### Iteration 3:

(T2-10 minutes since start) R1 is updated
1. The data from R1 is pulled from memory:
   R1 {Penalty: 20, time seen: T0, last halflife: T0}
   And add the penalty for this change:
   R1 {Penalty: 30, time seen: T0, last halflife: T0}
2. Only 10 minutes have passed no half life
3. Max cycle not reached
4. The PENALTY is 30 and exceeds the threshold
   Route is now dampened

### Iteration 4:

(T3-20 minutes since start) R1 is updated
1. The data from R1 is pulled from memory:
   R1 {Penalty: 30, time seen: T0, last halflife: T0}
   And add the penalty for this change:
   R1 {Penalty: 40, time seen: T0, last halflife: T0}
2. 20 minutes have passed, 1 half live. Cut penalty in half and update time
   R1 {Penalty: 20, time seen: T0, last halflife: T0+15 minutes}
3. Max cycle not reached
4. The PENALTY is 20 so the route is no longer dampened.
   Route is not dampened and exported

### Iteration 5:

(T4-40 minutes since start) R1 is updated
1. The data from R1 is pulled from memory:
   R1 {Penalty: 20, time seen: T0, last halflife: T0+15 minutes}
   And add the penalty for this change:
   R1 {Penalty: 30, time seen: T0, last halflife: T0+15 minutes}
2. 20 minutes have passed since last halflife, 1 half life. Cut penalty in half and update time
   R1 {Penalty: 15, time seen: T0, last halflife: T0+30 minutes}
3. Max cycle reached, time since T0>MAX CYCLE
   Remove route from internal DB
   Export the route, it is not dampened.

In some embodiments, the threshold value used to determine whether a route is classified as dampened or undampened may be dynamically configurable. The threshold may be established initially as a default system value and subsequently adjusted based on one or more factors such as network policy, tenant profile, or observed route update rate. For example, a service provider may maintain different threshold settings for different tenants or network segments depending on the size of the routing domain, traffic sensitivity, or stability requirements. In another embodiment, the route collector or control-plane service may automatically modify the threshold in response to detected changes in route update frequency, network load, or historical flapping patterns so that the dampening logic adapts to real-time operating conditions. The dynamically configurable threshold may be stored in a configuration datastore accessible to the route collector service and retrieved during each evaluation cycle of the dampening algorithm. Such configurability allows the system to tailor dampening sensitivity to particular deployment scenarios while maintaining consistent classification accuracy across heterogeneous cloud and on-premises environments.

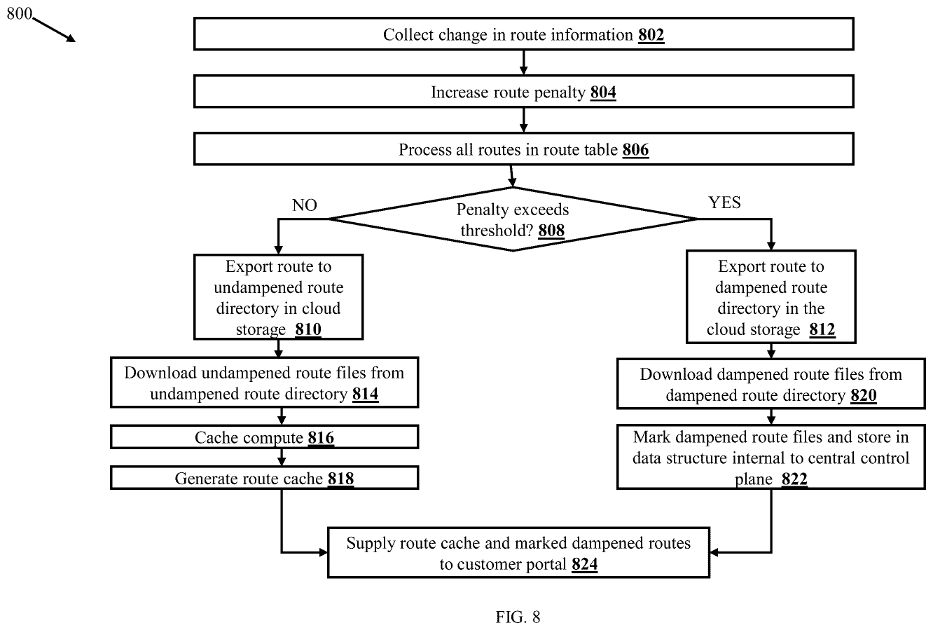

FIG. 8 is a flowchart that illustrates an example of a method for identifying unstable routes and reporting the unstable routes to customer portal in a hybrid multi-cloud network system, in accordance with an embodiment of the invention. FIG. 8 is explained in conjunction with elements from FIGS. 1-4, 5A, 5B, 6, and 7. With reference to FIG. 8, there is shown a flowchart 800. The operations from 802 to 824 may be implemented by any computing system, such as, nodes in the CXP 110, the central control plane 106, or a combination of both as shown in FIG. 1. The operations may start at 802 and may proceed to 824.

With the change in the routes connected to any of the nodes in the CXP 110 spread across multiple clouds provided by different vendors such as, but not limited to, AWS, Azure, GCP, or IBM cloud. In an example, a node 502 (as explained with reference to FIGS. 5A and 5B) may be connected to multiple routes. The node 502 may be sitting on a specific cloud such as AWS. The routes reaching the node 502 may be coming from a node hosted on a different cloud such as GCP. This way, the route table 508 stored on the node 502 may include all the routes reaching the node 502 from one or more other nodes hosted on different clouds. Whenever a state of any route reaching the node 502 changes, the complete route table 508 changes or updates. In an example, the change in the state of the route may be due to the route flapping or route being unstable. In another example, the change in the state of the route may also indicate that the route is advertised and withdrawn to the routing table frequently.

The route collector 506 of the node 502 periodically listens to such updates in the route table 508 and collects changes in the route's information at 802. When a route's information is updated, the route table 508 on the node 502 is updated. Then the route collector 506 collects the change by reading the route table 508. The change in the route is found by using the previously stored route's information.

At 804, when the route collector server 506 listens the change in the route's information, a penalty for the route is increased. In an example, the change in route's information increases the route penalty which may be calculated as per the half-life algorithm described with reference to description of FIG. 7.

At 806, the route collector server 506 listens to changes in information associated with all routes reaching the node 502. After listening to changes in the information associated with all the routes, the route collector server 506 processes the route table 508 to compare the penalty associated with each route to a threshold value of penalty at 808.

A route with a penalty less than the threshold penalty may be determined as undampened or a regular route. A route with a penalty greater than the threshold penalty may be determined as a dampened route.

At 810, routes which are determined to be undampened routes are exported to an undampened route directory in the cloud storage 312.

At 812, routes which are determined to be dampened routes are exported to a dampened route directory in the cloud storage 312. The dampened route directory and the undampened route directory are separately located in the cloud storage 312. In an example, the damped routes are located on a location different from the undampened routes in order to facilitate the route collector server to easily identify the undamped routes and bypass such routes from regular processing of cache computation, thus saving significant time.

After having the dampened and undampened routes in separate locations in the cloud storage 312, the route collector server 302 of the central control plane 106 handles them differently.

The route collector server 302 periodically listens to the updates in the cloud storage 312 and downloads the undampened route files from the undampened route directory, at 814.

At 816, the route collector server 302 computes cache for the undampened route files. Details of cache computation may be found in the description of FIGS. 4 and 6.

At 818, information from the undampened routes and information route visualization collected from other services, as explained with reference to description of FIG. 6, are used by the route collector server 302 to generate the route cache.

The damp route processor 302-1 of the route collector server 302 periodically listens to the updates in the cloud storage 312 and downloads the dampened route files from the dampened route directory, at 820.

At 822, the damp route processor 302-1 marks the dampened route files and stores in a data structure, for example Damp Route Data 302-2, internal to the central control plane 106. After identifying dampened routes, they may be prevented from causing extra visualization updates. The dampened routes may then be marked to the customer as potentially problematic routes. Removing the extra updates will improve the latency of network information reaching the customer portal while marking routes can lead to discovery of ways the network can be improved.

At 824, after receiving an API query from the customer portal 102, the API request handler 310 supplies the generated route cache and the marked dampened routes to customer portal 102. The problem with the unstable routes is that such routes are being constantly withdrawn or advertised and cause the visualization workflow of the network to be slowed with frequent and unnecessary updates. These routes are commonly due to misconfigurations on or issues with various entities in the system. After identifying such routes at 812 and marking them at 822, it becomes easy to fix them and alleviate the problems caused by such routes.

The route cache is provided to the customer portal 102 through an API and displays route information to the customer where they can find a global display of their network. In an embodiment, routes that are dampened are marked and shown under a separate tab.

Although the flowchart 800 is illustrated as discrete operations, such as 802, 804, 806, 808, 810, 812, 814, 816, 818, 820, 822, and 824 the invention is not so limited. Accordingly, in certain embodiments, such discrete operations may be further divided into additional operations, combined into fewer operations, or eliminated, depending on the implementation without detracting from the essence of the disclosed embodiments.

Various embodiments of the invention may provide a non-transitory computer-readable medium and/or storage medium having stored thereon, computer-executable instructions executable by a machine and/or a computer to operate an electronic device (such as the central control plane 106 and the CXP 110). The computer-executable instructions may cause the machine and/or computer to perform operations as described with reference to steps/functions performed by the central control plane 106 and the CXP 110 in flowchart illustrated by FIG. 8.

Exemplary aspects of the invention may include a system (such as the central control plane 106 and the CXP 110 of FIG. 1) that may include circuitry or processor. The system may include one or more hardware processors. The system may also include a memory storing instructions that, when executed by the one or more hardware processors, cause the system to perform operations as described with reference to steps/functions performed by the central control plane 106 and the CXP 110 in flowchart illustrated by FIG. 8.

The present invention may be realized in hardware, or a combination of hardware and software. The present invention may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present invention may be realized in hardware that comprises a portion of an integrated circuit that also performs other functions.

The present invention may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present invention is described with reference to certain embodiments, it will be understood by those skilled in the art that various changes may be made, and equivalents may be substituted without departure from the scope of the present invention. In addition, many modifications may be made to adapt a particular situation or material to the teachings of the present invention without departure from its scope. Therefore, it is intended that the present invention is not limited to the embodiment disclosed.

What is claimed is:

1. A computer-implemented method for managing route information in a distributed network environment, comprising:
monitoring routing information associated with a plurality of routes within the distributed network environment;
recording a stability value for each of the plurality of routes;
classifying the plurality of routes into a first set of routes comprising routes identified as unstable based on the stability value and a second set of routes comprising routes identified as stable;
processing the first set of routes and the second set of routes according to different processing paths, wherein
the first set of routes is processed through a first processing path that limits or defers computational operations associated with route updates, and
the second set of routes is processed through a second processing path that updates a network representation reflecting current route information; and
storing or providing information identifying at least the first set of routes as routes exhibiting unstable behaviour.

2. The method of claim 1, further comprising increasing the stability value for a route of the plurality of routes responsive to each detected change in the routing information associated with the corresponding route, and decreasing the stability value over time according to a decay function.

3. The method of claim 2, wherein the decay function comprises halving the stability value after a predetermined half-life interval has elapsed since a last route update.

4. The method of claim 2, wherein the stability value is reset when a maximum tracking interval has elapsed.

5. The method of claim 1, further comprising comparing the stability value for each route with a threshold value and assigning the route to the first set or the second set of routes based on the comparison.

6. The method of claim 5, wherein the threshold value is dynamically configurable based on network policy, tenant profile, or observed update rate.

7. The method of claim 1, wherein monitoring the routing information comprises detecting changes to one or more route tables of network nodes and generating delta data representing updated routes.

8. The method of claim 1, further comprising exporting the first set and the second set of routes to separate logical stores or directories within a storage system.

9. The method of claim 8, wherein the separate logical stores comprise a dampened-route store and an undampened-route store, each accessible independently by downstream processing components.

10. The method of claim 1, wherein the first processing path includes marking each route of the first set as unstable in a data structure configured to store route identifiers and stability metadata and bypassing one or more computational stages used for the second processing path.

11. The method of claim 10, wherein bypassed computational stages include re-computation of a route cache that aggregates routes from multiple sources.

12. The method of claim 1, wherein the second processing path includes aggregating, deduplicating, and updating a route cache representing stable routes of the second set of routes.

13. The method of claim 1, further comprising providing, through an application programming interface, information identifying routes of the first set and the second set of routes to a user interface.

14. The method of claim 13, further comprising causing the user interface to display a network representation in which routes of the first set of routes are visually distinguished from routes of the second set of routes.

15. The method of claim 14, wherein the displaying includes preventing the first set of routes from initiating visualization refreshes while still providing access to their identifiers and instability indicators.

16. The method of claim 1, further comprising generating alerts or recommendations for network entities associated with the first set of routes to facilitate configuration verification or remediation.

17. The method of claim 1, wherein the first processing path executes within a shorter processing interval than the second processing path to provide identification of unstable routes within a processing interval shorter than that of the second processing path.

18. The method of claim 1, further comprising periodically re-evaluating the first set of routes and migrating specific routes from the first set of routes to the second set of routes upon determining that the specific routes are stabilized.

19. A system for managing route information in a distributed network environment, comprising:
one or more processors; and
one or more memory devices storing instructions that, when executed by the one or more processors, cause the system to:
monitor routing information associated with a plurality of routes within the distributed network environment;
record a stability value for each of the plurality of routes;
classify the plurality of routes into a first set of routes comprising routes identified as unstable based on the stability value and a second set of routes comprising routes identified as stable;
process the first set of routes and the second set of routes according to different processing paths, wherein
the first set of routes is processed through a first processing path that limits or defers computational operations associated with route updates, and
the second set of routes is processed through a second processing path that updates a network representation reflecting current route information; and
store or provide information identifying at least the first set of routes as routes exhibiting unstable behaviour.

20. A non-transitory computer-readable medium storing instructions that, when executed by one or more processors, cause the one or more processors to perform a method comprising:
monitoring routing information associated with a plurality of routes within a distributed network environment;
recording a stability value for each of the plurality of routes;
classifying the plurality of routes into a first set of routes comprising routes identified as unstable based on the stability value and a second set of routes comprising routes identified as stable;
processing the first set of routes and the second set of routes according to different processing paths, wherein
the first set of routes is processed through a first processing path that limits or defers computational operations associated with route updates, and
the second set of routes is processed through a second processing path that updates a network representation reflecting current route information; and
storing or providing information identifying at least the first set of routes as routes exhibiting unstable behaviour.
